(19) United States
(12) Patent Application Publication
(10) Pub. No.: US 2015/0176137 A1
(43) Pub. Date: Jun. 25, 2015

(54) METHODS FOR PREPARING SUBSTRATE CORED-METAL LAYER SHELLED METAL ALLOYS

(71) Applicant: UNIVERSITY OF CONNECTICUT, Farmington, CT (US)

(72) Inventors: Steven L. SUIB, Storrs, CT (US); Hui HUANG, Willington, CT (US)

(21) Appl. No.: 14/576,250

(22) Filed: Dec. 19, 2014

Related U.S. Application Data
(60) Provisional application No. 61/919,052, filed on Dec. 20, 2013.

(51) Int. Cl. C23C 22/73; H01M 4/36; H01M 4/38; B22F 1/02; C23C 22/02

(52) U.S. Cl. CPC C23C 22/73; B22F 1/025; C23C 22/02; H01M 4/38; H01M 4/366

(57) ABSTRACT

A process is provided that involves contacting a metal substrate with a bath. The bath includes one or more metallic precursors and one or more organic solvents. The process also includes conducting a replacement reaction between the metal substrate and the one or more metallic precursors. The replacement reaction is conducted under controlled reaction conditions sufficient to produce one or more substrate cored-metal layer shelled metal alloys. Substrate cored-metal layer shelled metal alloys prepared by the process of this disclosure are also provided. The substrate cored-metal layer shelled metal alloys of this disclosure can have many important applications, such as functioning as heterogeneous catalysts in fuel reforming processes and as electrode materials in thin film Li batteries for energy storage.

### RELATED APPLICATION

This application claims the benefit of U.S. Provisional Application Ser. No. 61/919,052, filed on Dec. 20, 2013, which is incorporated herein by reference.

### BACKGROUND OF THE DISCLOSURE

1. Field of the Disclosure

This disclosure relates to methods for preparing substrate cored-metal layer shelled metal alloys. These substrate cored-metal layer shelled metal alloys can have many important applications, such as functioning as heterogeneous catalysts in fuel reforming processes and as electrode materials in thin film Li batteries for energy storage.

2. Discussion of the Background Art

The construction of core-shelled alloys is a known process used to tailor the physical and chemical properties of an existing substrate. Current methods of making metallic alloys rely on high temperature or high pressure conditions, which limit large-scale producing and increase the cost of such products. In carbon thermal reductive processes, carbon was ballmilled with metallic precursors and heated up to 850° C. to yield such alloys. Argon was normally used as a protective gas; meanwhile carbon monoxide waste gas was generated.

Such process involves using carrier gas and a sophisticated setup and initiates the treatment of harmful waste-gas problems. In gas processes, hydrogen gas was used to reduce metal oxide alloy precursors. Critical experiment conditions and expensive syngas were concerns for production of bulky materials. In wet chemistry processes, harsh reducing reagents, such as hydrazine, hydroxylamine, NaBH₄, or borane, were used to reduce metal precursors. These reducing reagents require special handling due to their reactive properties. These processes are normally done in sealed pressure vessels at different temperatures. The limited reaction vessel volume eliminates the possibility of facile and large-scale preparation of such alloys.

All the aforementioned methods not only potentially bring up safety issues in terms of chemical storage and operational management, but also unavoidably increase production cost. What is needed is a green, easy-handling, and economic process for producing such metallic alloys.

The present disclosure provides many advantages over the prior art, which shall become apparent as described below.

### SUMMARY OF THE DISCLOSURE

This disclosure provides a method for preparing substrate cored-metal layer shelled metal alloys that successfully reduces producing cost, offers greener chemical reactions, and simplifies manufacturing operations.

The disclosure also provides a process that involves contacting a metal substrate with a bath in which the bath comprises one or more metallic precursors and one or more organic solvents, and conducting a replacement reaction between the metal substrate and the one or more metallic precursors. The replacement reaction is conducted under controlled reaction conditions sufficient to produce one or more substrate cored-metal layer shelled metal alloys.

In accordance with this disclosure, the replacement reaction rate is controlled sufficient to produce the one or more substrate cored-metal layer shelled metal alloys. The replacement reaction pressure, temperature and reaction time are all controlled sufficient to produce the one or more substrate cored-metal layer shelled metal alloys.

This disclosure further provides, in part, to a substrate cored-metal layer shelled metal alloy prepared by the process of this disclosure.

This disclosure yet further provides, in part, to the process of this disclosure in which one or more carbon based or silicon based materials are added to the bath to form an ink suspension. The one or more carbon based or silicon based materials are selected from the group consisting of carbon black, graphite, carbon nanotubes, fullerene, and silicon nanomaterials. A metallic alloy/carbon or metallic alloy/silicone nanocomposite is formed from the ink suspension.

This disclosure also provides, in part, to a metallic alloy/carbon or metallic alloy/silicone nanocomposite prepared by the process of this disclosure.

The substrate cored-metal layer shelled metal alloys of this disclosure can have many important applications, such as functioning as heterogeneous catalysts in fuel reforming processes and as electrode materials in thin film Li batteries for energy storage. The metallic alloy/carbon or metallic alloy/silicone nanocomposites of this disclosure can have many important applications, such as functioning as electrode materials in thin film Li batteries for energy storage.

Further objects, features and advantages of the present disclosure will be understood by reference to the following drawings and detailed description.

### BRIEF DESCRIPTION OF THE DRAWINGS

FIG. 1 depicts an illustrative methodology for preparing the substrate cored-metal layer shelled metal alloys in accordance with this disclosure.

FIG. 2 depicts an illustrative scheme of a reaction set up for conducting the process of this disclosure.

FIG. 3 depicts x-ray diffraction (XRD) patterns of (a) Fe/SnSb and (b) Zn/SnSb product respectively produced in accordance with the process of this disclosure.

FIG. 4 depicts scanning electron microscopy (SEM) images and energy dispersive x-ray (EDX) spectroscopy mapping of a Fe/SnSb product prepared in accordance with the process of this disclosure.

FIG. 5 depicts the composition of the Fe/SnSb product shown in FIG. 4 and prepared in accordance with the process of this disclosure.

FIG. 6 depicts scanning electron microscopy (SEM) images and energy dispersive x-ray (EDX) spectroscopy mapping of a Zn/SnSb product prepared in accordance with the process of this disclosure.

FIG. 7 depicts the composition of the Zn/SnSb product shown in FIG. 6 and prepared in accordance with the process of this disclosure.

FIG. 8 depicts an Auger analysis of the Zn/SnSb product shown in FIG. 6 and prepared in accordance with the process of this disclosure.

FIG. 9 depicts an illustrative methodology for preparing the substrate cored-metal layer shelled metal alloys in accordance with this disclosure.

FIG. 10 depicts x-ray diffraction (XRD) patterns of a Fe/SnSb product produced in accordance with the process of this disclosure.

FIG. 11 graphically depicts a compositional analysis of the Fe/SnSb product of FIG. 10 produced in accordance with the process of this disclosure.

FIG. 12 graphically depicts crystallite size (nanometers) of the Fe/SnSb product of FIG. 10 produced in accordance with the process of this disclosure.

FIG. 13 depicts a scanning electron microscopy (SEM) image of a Fe/SnSb product prepared in accordance with the process of this disclosure.

FIG. 14 depicts energy dispersive x-ray (EDX) spectroscopy mapping of a Fe/SnSb product prepared in accordance with the process of this disclosure.

FIG. 15 depicts a high resolution scanning electron microscopy (SEM) image of a Fe/SnSb product prepared in accordance with the process of this disclosure.

FIG. 16 depicts x-ray diffraction (XRD) patterns of a Zn/Sb product produced in accordance with the process of this disclosure.

FIG. 17 graphically depicts a compositional analysis of the Zn/Sb product of FIG. 16 produced in accordance with the process of this disclosure.

FIG. 18 graphically depicts crystallite size (nanometers) of the Zn/Sb product of FIG. 16 produced in accordance with the process of this disclosure.

FIG. 19 depicts a scanning electron microscopy (SEM) image of a Zn/Sb product prepared in accordance with the process of this disclosure.

FIG. 20 depicts energy dispersive x-ray (EDX) spectroscopy mapping of a Zn/Sb product prepared in accordance with the process of this disclosure.

FIG. 21 depicts a high resolution scanning electron microscopy (SEM) image of a Zn/Sb product prepared in accordance with the process of this disclosure.

FIG. 22 depicts the AccuTOF-DART (Direct Analysis in Real Time) analysis results (naphthalene (M.W. 128)+toluene (M.W. 92)) untreated in accordance with Example 3 of this disclosure.

FIG. 23 depicts the AccuTOF-DART (Direct Analysis in Real Time) analysis results (naphthalene (M.W. 128)+toluene (M.W. 92)+alloy cat) from the treatment of compounds with a substrate cored-metal layer shelled metal alloy catalyst in accordance with Example 3 of this disclosure.

FIG. 24 depicts the AccuTOF-DART (Direct Analysis in Real Time) analysis results (naphthalene (M.W. 128)+toluene (M.W. 92)+gasoline+alloy cat) from the treatment of compounds with a substrate cored-metal layer shelled metal alloy catalyst in accordance with Example 3 of this disclosure.

FIG. 25 depicts the AccuTOF-DART (Direct Analysis in Real Time) analysis results (naphthalene (M.W. 128)+toluene (M.W. 92)+diesel fuel+alloy cat) from the treatment of compounds with a substrate cored-metal layer shelled metal alloy catalyst in accordance with Example 3 of this disclosure.

FIG. 26 depicts the AccuTOF-DART (Direct Analysis in Real Time) analysis results (naphthalene (M.W. 128)+toluene (M.W. 92)+pentane (M.W.

72)+alloy cat) from the treatment of compounds with a substrate cored-metal layer shelled metal alloy catalyst in accordance with Example 3 of this disclosure.

FIG. 27 depicts the AccuTOF-DART (Direct Analysis in Real Time) analysis results (naphthalene (M.W. 128)+toluene (M.W. 92)+hexanes (M.W. 86)+alloy cat) from the treatment of compounds with a substrate cored-metal layer shelled metal alloy catalyst in accordance with Example 3 of this disclosure.

FIG. 28 depicts the AccuTOF-DART (Direct Analysis in Real Time) analysis results (naphthalene (M.W. 128)+toluene (M.W. 92)+comparative cat) from the treatment of compounds with a comparative catalyst in accordance with Example 3 of this disclosure.

FIG. 29 depicts the AccuTOF-DART (Direct Analysis in Real Time) analysis results (cumene (M.W. 120)) untreated in accordance with Example 3 of this disclosure.

FIG. 30 depicts the AccuTOF-DART (Direct Analysis in Real Time) analysis results (cumene (M.W. 120)+alloy cat) from the treatment of compounds with a substrate cored-metal layer shelled metal alloy catalyst in accordance with Example 3 of this disclosure.

FIG. 31 depicts the AccuTOF-DART (Direct Analysis in Real Time) analysis results (cumene (M.W. 120)+gasoline+alloy cat) from the treatment of compounds with a substrate cored-metal layer shelled metal alloy catalyst in accordance with Example 3 of this disclosure.

FIG. 32 depicts the AccuTOF-DART (Direct Analysis in Real Time) analysis results (cumene (M.W. 120)+diesel fuel+alloy cat) from the treatment of compounds with a substrate cored-metal layer shelled metal alloy catalyst in accordance with Example 3 of this disclosure.

FIG. 33 depicts the AccuTOF-DART (Direct Analysis in Real Time) analysis results (cumene (M.W. 120)+pentane (M.W. 72)+alloy cat) from the treatment of compounds with a substrate cored-metal layer shelled metal alloy catalyst in accordance with Example 3 of this disclosure.

FIG. 34 depicts the AccuTOF-DART (Direct Analysis in Real Time) analysis results (cumene (M.W. 120)+hexanes (M.W. 86)+alloy cat) from the treatment of compounds with a substrate cored-metal layer shelled metal alloy catalyst in accordance with Example 3 of this disclosure.

FIG. 35 depicts the AccuTOF-DART (Direct Analysis in Real Time) analysis results (cumene (M.W. 120)+comparative cat) from the treatment of compounds with a comparative catalyst in accordance with Example 3 of this disclosure.

FIG. 36 depicts the AccuTOF-DART (Direct Analysis in Real Time) analysis results (gasoline) untreated in accordance with Example 3 of this disclosure.

FIG. 37 depicts the AccuTOF-DART (Direct Analysis in Real Time) analysis results (diesel fuel) untreated in accordance with Example 3 of this disclosure.

FIG. 38 depicts the AccuTOF-DART (Direct Analysis in Real Time) analysis results (pentane (M.W. 72)) untreated in accordance with Example 3 of this disclosure.

FIG. 39 depicts the AccuTOF-DART (Direct Analysis in Real Time) analysis results (hexanes (M.W. 86)) untreated in accordance with Example 3 of this disclosure.

FIG. 40 depicts the AccuTOF-DART (Direct Analysis in Real Time) analysis results (gasoline+alloy cat) from the treatment of compounds with a substrate cored-metal layer shelled metal alloy catalyst in accordance with Example 3 of this disclosure.

FIG. 41 depicts the AccuTOF-DART (Direct Analysis in Real Time) analysis results (diesel fuel+alloy cat) from the treatment of compounds with a substrate cored-metal layer shelled metal alloy catalyst in accordance with Example 3 of this disclosure.

FIG. 42 depicts the AccuTOF-DART (Direct Analysis in Real Time) analysis results (pentane (M.W. 72)+alloy cat) from the treatment of compounds with a substrate cored-metal layer shelled metal alloy catalyst in accordance with Example 3 of this disclosure.

FIG. 43 depicts the AccuTOF-DART (Direct Analysis in Real Time) analysis results (hexanes (M.W. 86)+alloy cat) from the treatment of compounds with a substrate cored-metal layer shelled metal alloy catalyst in accordance with Example 3 of this disclosure.

FIG. 44 depicts the AccuTOF-DART (Direct Analysis in Real Time) analysis results (gasoline+comparative cat) from the treatment of compounds with a comparative catalyst in accordance with Example 3 of this disclosure.

FIG. 45 depicts the AccuTOF-DART (Direct Analysis in Real Time) analysis results (diesel fuel+comparative cat) from the treatment of compounds with a comparative catalyst in accordance with Example 3 of this disclosure.

FIG. 46 depicts the AccuTOF-DART (Direct Analysis in Real Time) analysis results (pentane (M.W. 72)+comparative cat) from the treatment of compounds with a comparative catalyst in accordance with Example 3 of this disclosure.

FIG. 47 depicts the AccuTOF-DART (Direct Analysis in Real Time) analysis results (hexanes (M.W. 86)+comparative cat) from the treatment of compounds with a comparative catalyst in accordance with Example 3 of this disclosure.

### DETAILED DESCRIPTION OF THE PREFERRED EMBODIMENT

All numerical values within the detailed description and the claims herein are modified by “about” or “approximately” the indicated value, and take into account experimental error and variations that would be expected by a person having ordinary skill in the art.

The process of the present disclosure provides a new family of single or multiple metal shelled and single metal cored alloys (e.g., substrate cored-metal layer shelled metal alloys). The process for preparing the substrate cored-metal layer shelled metal alloy involves reacting the metal substrate and the one or more metallic precursors under controlled reaction conditions sufficient to produce one or more substrate cored-metal layer shelled metal alloys. The replacement reaction rate is controlled sufficient to produce the one or more substrate cored-metal layer shelled metal alloys. The replacement reaction pressure, temperature and reaction time are all controlled sufficient to produce the one or more substrate cored-metal layer shelled metal alloys.

An important feature of the process of this disclosure involves controlling the galvanic replacement reaction rate between substrates and metallic precursors. The substrates can be reacted with one or more metallic precursors under controlled reaction times and temperatures. These substrate cored-metal layer shelled metal alloy can have many important chemical applications, such as functioning as heterogeneous catalysts in fuel reforming processes and electrode materials in thin film Li batteries for energy storage. The weight to functional surface ratio of substrate cored-metal layer shelled metal alloy catalysts made with this protocol is only 2% of commercial fuel reforming catalyst produced by Advanced Power System International (APSI).

The choices of deposition substrate and solvent are important for conducting the process of this disclosure. For example, to coat Sn, Sb, Bi, and Pb on the substrate, the metal foil must be more active in terms of metal activity order. Namely, metals such as Mg, Zn, and Fe can be used. These metals are relatively cheap and have an activity order of Mg>Zn>Fe, which is more active than Sn, Pb, and the like. Mixed solvents are better to mediate the reaction rate. For example, the combination of ethanol and ethylene glycol are better for the use of Zn foil as the substrate.

In accordance with this disclosure, a galvanic replacement process can be used to prepare core-shelled multiple metal alloys in the presence of mixed organic solvents under atmospheric conditions. The use of thin relatively active metal foils, such as Mg, Al, Fe, Zn, as reductive reagents as well as substrates to deposit multiple metal alloys which may include single or combined multiple metal of Sn, Pb, Sb, Bi, Co, Ni, In, Cu, Hg, Ag, Pt, Pd, and Au. The use of mixed environmentally benign organic solvents at favorable low temperatures mediates the galvanic reaction rate, ending up with a single metal cored, single or multiple metal shelled alloys.

Adding other carbon or silicon based materials, such as carbon black, graphite, graphene, carbon nanotubes, fullerene, silicon nanomaterials into the mixed organic solution can result in an ‘ink’ suspension that can lead to the formation of more advanced metallic alloy/carbon or metallic alloy/silicon nanocomposites. Such nanocomposites can be useful for electrode materials for Li batteries.

As used herein, the term “alloy” generally describes a solid solution comprising greater than or equal to two constituent elements, as opposed to a mixture containing phases of the constituent elements. The term “substrate” is used herein for convenience, and includes materials having irregular shapes such as flakes as well as regular shapes such as for example spheres, sheets, films, mesh, or honeycomb. The term “bath” has its ordinary meaning as used herein and includes a solution, exclusive of the vessel, in which the alloy is formed. It is to be understood that “solution” as used herein refers to liquids in which the bath components have been fully or partially dissolved.

Baths suitable for the formation of substrate cored-metal layer shelled metal alloys having nanometer or micrometer sized grains are solutions formed from one or more salts comprising each constituent element of the alloy and a reducing agent in an organic medium. Other additives known in the art may also be used. In an embodiment, the metal foils used in the processes of this disclosure can be bi-functionally used as substrates and reducing reagents in the presence of mixed organic solvents and desired metallic precursors.

The baths are formed from one or more salts that provide the constituent elements of the alloy. As used herein, “salts” is inclusive of any species that can provide the constituent element in the process of this disclosure. Such salts generally comprise a cation and an anion. The salts may be complex, i.e., formed from one or more cations and/or anions. The constituent element is generally present as a cation in any of its oxidation states. Suitable constituent elements therefore include the cations of metals such as Sn, Sb, Pt, Rh, Bi, Hg, Pb, Cu, Ag, Au, In, Cd, Zn, Si, Ge, As, Pd, Co, and Ni. In one embodiment, the cation is a cation of Sn, Sb, Pb and Bi.

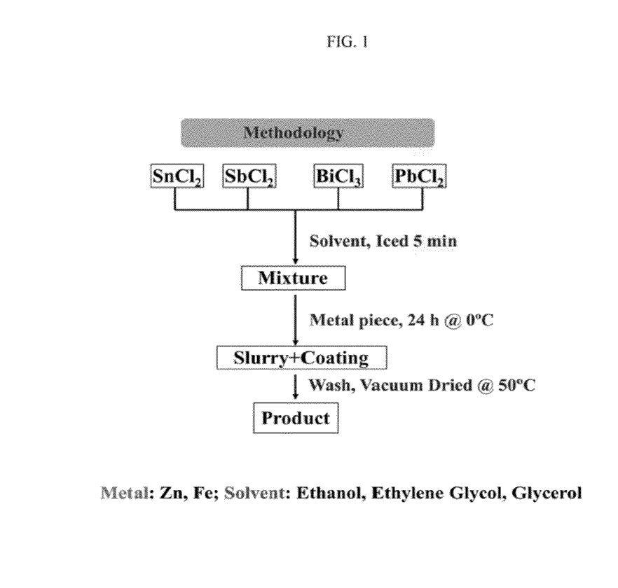

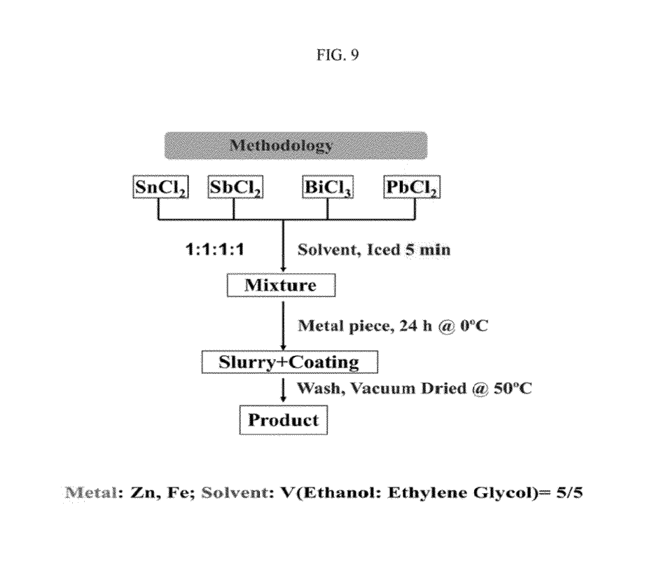

The anion is selected so as to allow the cation to react in the process to form the alloy. For example, the anion is such that it may dissociate from the cation and provide a free cation, coordination complex, or other reactive species to the bath. Examples of suitable anions include halides, such as fluoride, chloride, bromide, and iodide; chalcogenides such as sulfide, selenide, and telluride; oxides; nitrides; pnictides such as phosphide, and antimonide; nitrates; nitrites; sulfates; sulfites; acetates; and carbonates. In an exemplary embodiment, the anions are chlorides. See the process methodology illustrated in FIGS. 1 and 9.

A single salt can be used to provide more than one constituent element. In another embodiment, more than one salt, i.e., a mixture of salts, can be used to provide the same constituent element. The amount of each salt present in the bath is about 10 to about 35 grams per liter of bath (g/L). Specifically, the amount of each salt present in the bath is about 15 to about 30 g/L and more specifically about 18 to about 25 g/L.

The reducing agent in the bath reacts with the cation, coordination complex, or other reactive species to reduce the constituent metal to its elemental oxidation state. Examples of suitable reducing agents include alkali metal borohydrides, hydrazine, and boranes such as dimethylaminoborane. In an exemplary embodiment, the reducing agent can be potassium borohydride (KBH₄). The amount of reducing agent present in the bath is about 10 to about 50 g/L. Specifically, the amount of reducing agent present in the bath is about 12 to about 40 g/L, and more specifically about 15 to about 35 g/L. As described herein, the metal foils used in the processes of this disclosure can be bi-functionally used as substrates and reducing reagents in the presence of mixed organic solvents and desired metallic precursors.

The baths are formed in a non-aqueous medium, i.e., an organic medium. Desirably, the organic medium acts as both a solvent and a chelating or complexing agent. The organic medium is selected such that it will mediate the reaction rate and preparation of the one or more substrate cored-metal layer shelled metal alloys. The organic medium can make the reaction mild and slow. Suitable organic media include, for example, organic solvent such as ethanol, ethylene glycol, glycerol, diethylene glycol, triethylene glycol, and mixtures thereof. Other organic solvents include, for example, diamines such as ethylenediamine, ethylenediaminetetraacetic acid (EDTA), and the like. In an exemplary embodiment, the organic medium is a mixture of ethanol, ethylene glycol, and glycerol. In another exemplary embodiment, the organic medium is a mixture of ethanol and ethylene glycol. The amount of organic medium present in the bath is about 500 to about 800 g/L. Specifically, the amount of organic medium present in the bath is about 550 to about 720 g/L, and more specifically about 600 to about 700 g/L.

In one embodiment, the bath can contain other components known in the art. Preferably, however, the bath contains essentially no substances capable of suppressing the process of this disclosure, and creates no hazardous substances. The composition is highly stable and does not require the addition of non-volatile stabilizers, accelerators, pH regulators or other chemical agents used to enhance alloy-forming properties.

In an embodiment, the baths are used in the formation one or more substrate cored-metal layer shelled metal alloys. The substrate cored-metal layer shelled metal alloys are formed by contacting a substrate with the bath under controlled conditions of temperature, pressure and reaction time described herein. The process is autocatalytic, in that no catalyst separate from the aforementioned components is required to advance the formation of the substrate cored-metal layer shelled metal alloys. Optionally, the contacting comprises complete submersion of the substrate into the bath. In one advantageous feature, more than one substrate can be subjected to contacting simultaneously.

Suitable substrates are catalytically active surfaces and are most commonly metallic. Suitable materials for the metallic substrate are transition group metals, rare earth metals including lanthanides and actinides, alkali metals, alkaline earth metals, main group metals, alloys comprising at least one of the foregoing metals, and combinations comprising at least one of the foregoing materials. In a specific embodiment, the metallic substrate is copper, iron, molybdenum, indium, cadmium, stainless steel, carbon steel, nickel, chromium, iron-chromium alloys, and nickel-chromium-iron alloys, and the like, as well as combinations comprising at least one of the foregoing materials. In a preferred embodiment, the metal substrate is one or more of magnesium, aluminum, iron, and zinc.

Formation of the one or more substrate cored-metal layer shelled metal alloys occurs within the bath vessel. In one embodiment, the bath vessel comprises interior facing walls formed of an inert material. Use of an inert material helps to prevent the formation of byproducts. The inert material is selected such that it is inert to the bath and can withstand the reaction conditions.

In one embodiment the inert material is a fluorinated polymer. Suitable fluorinated polymers include tetrafluoroethylene (TFE), polytetrafluoroethylene (PTFE), fluoro(ethylene-propylene) (FEP), and the like.

The pressure, reaction time and temperature affect the galvanic replacement reaction rate and grain size, and can vary depending on the particular bath components and desired reaction rate and grain size. Suitable conditions can be determined by one of ordinary skill in the art without undue experimentation using the guidelines provided herein. The temperature can have an effect on reaction rate, while the heating time can have an effect on grain size. The reaction rate increases with heating temperature and grain size increases with heating time.

In one embodiment, a refrigerator or ice bath is used to control the reaction temperatures at 0° C.-2° C. when necessary, otherwise the reaction is carried out at ambient temperature. The reaction is preferably carried out at atmospheric pressure. Typically, the substrate remains in the bath for from about 1 minute to about 24 hours, depending on the required formation of substrate cored-metal layer shelled metal alloys, preferably from about 240 minutes to about 12 hours.

In particular, reaction conditions for the reaction of the metal substrate with the one or more metallic precursors, such as temperature, pressure and contact time, can also vary and any suitable combination of such conditions can be employed herein for controlling the replacement reaction. The reaction temperature can be between about −15° C. to about 25° C., and more preferably between about −10° C. to about 15° C., and most preferably between about −5° C. to about 5° C. Normally, the reaction is carried out under ambient pressure and the contact time can vary from a matter of seconds or minutes to a few hours or greater. The reactants can be added to the reaction mixture or combined in any order. The contact time employed can range from about 0.1 to about 24 hours, preferably from about 0.5 to 15 hours, and more preferably from about 1 to 5 hours. If the replacement reaction conditions are not controlled (e.g., by temperature, time, and organic solvent), the replacement reaction would continue to happen until the metallic precursors consumed all the substrate or the metallic precursors all got all consumed.

After the desired amount of formation of substrate cored-metal layer shelled metal alloys, the reacted substrate is removed from the bath solution. The result is one or more substrate cored-metal layer shelled metal alloys comprising nanometer or micrometer sized grains and having good properties. These substrate cored-metal layer shelled metal alloys can have many important chemical applications, such as functioning as heterogeneous catalysts in fuel reforming processes and electrode materials in thin film Li batteries for energy storage. The process of this disclosure can also be done by contacting a substrate surface with a bath by any other technique such as spraying, pouring, brushing, and the like, and then subjecting the contacted substrate to the aforementioned conditions.

The grain size of the nanometer or micrometer scale substrate cored-metal layer shelled metal alloys produced by the process of this disclosure have average about 1 nanometers (nm) to about 1000 nm, specifically about 50 nm to about 800 nm. Substrate cored-metal layer shelled metal alloys having an average thickness of about 20 to about 100 micrometers, more specifically about 40 to about 80 micrometers can be produced.

The substrate cored-metal layer shelled metal alloys prepared by the process of this disclosure can be utilized for octane enhancement of petroleum fuels. In petroleum industry and mogas parlance, octane is a measure of a gasoline's resistance to pre-ignition or “knock”. Gasolines are tested against a standard branched-chain hydrocarbon called isooctane (2,2-dimethyl-4-methylpentane) which is assigned octane=100 (or “100 octane”). Octane numbers can be measured by different tests, called, for example, research (RON) and motor octane (MON). The substrate cored-metal layer shelled metal alloys prepared by the process of this disclosure can be utilized for electrode materials in thin film Li batteries for energy storage.

In the above detailed description, the specific embodiments of this disclosure have been described in connection with its preferred embodiments. However, to the extent that the above description is specific to a particular embodiment or a particular use of this disclosure, this is intended to be illustrative only and merely provides a concise description of the exemplary embodiments. Accordingly, the disclosure is not limited to the specific embodiments described above, but rather, the disclosure includes all alternatives, modifications, and equivalents falling within the true scope of the appended claims. Various modifications and variations of this disclosure will be obvious to a worker skilled in the art and it is to be understood that such modifications and variations are to be included within the purview of this application and the spirit and scope of the claims.

All reactions in the following examples were performed using as-received starting materials without any purification.

### Example 1

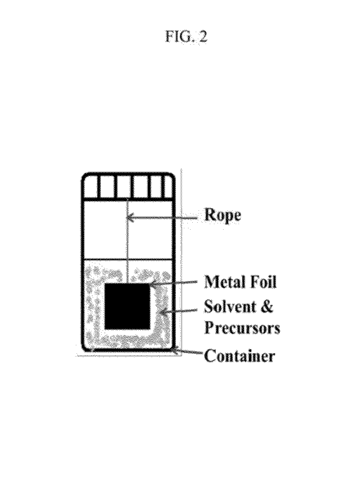

Substrate cored-metal layer shelled metal alloys were prepared in accordance with the methodology shown in FIG. 1. Metal foils were suspended in a container, which was filled with suitable single or mixed metal salt precursors and mixed organic solvents for different times at variable temperatures as illustrated in FIG. 2. Relatively active metal foils were Mg, Al, Zn, Fe, Ni, and the like. A refrigerator or ice bath was used to control the reaction temperatures at 0° C.-2° C. when necessary; otherwise the reaction was done at ambient temperature. The cationic part of metallic precursors contained one or several metals like Sn, Pb, Sb, Bi, Co, Ni, In, Cu, Hg, Ag, Pt, Pd, and Au, while the anionic part contained sulfate, nitrate, chloride, acetate, or acetylacetonate. The organic solvents used were one or several of the type ethanol, ethylene glycol, and glycerol. The reaction time was set between 30 minutes and 12 hours.

0.54 grams SnCl₂, 0.39 grams SbCl₃, 0.01 grams BiCl₃, and 0.01 grams PbCl₂ were dissolved in a mixed solvent which contained 5 milliliters of ethanol and 5 milliliters of ethylene glycol in a 25 milliliter vial. A piece of 1 centimeter×1 centimeter×0.1 millimeter Fe foil was suspended in such mixture at 0° C. A piece of 1 centimeter×1 centimeter×0.25 millimeter Zn foil was also used in mixed solvent which contained 5 milliliters of glycerol and 5 milliliters of ethylene glycol in a 25 milliliter vial. A polyvinylpyrrolidone (PVP) surfactant can be utilized to control the particle sizes of formed alloy shells if desired.

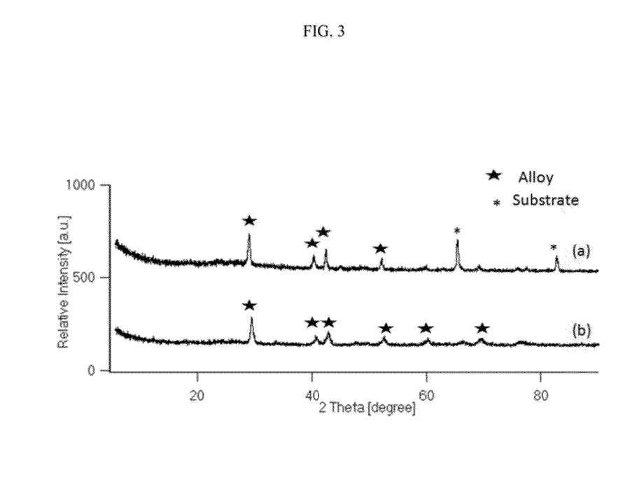

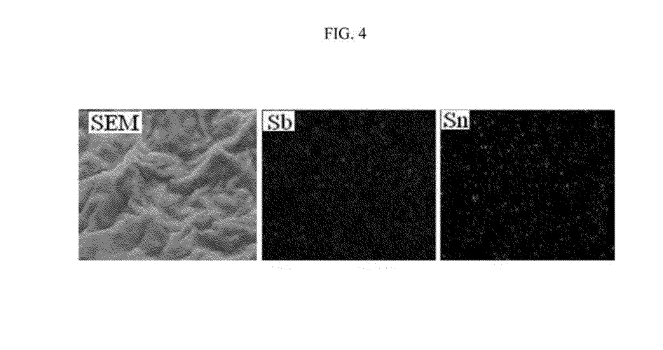

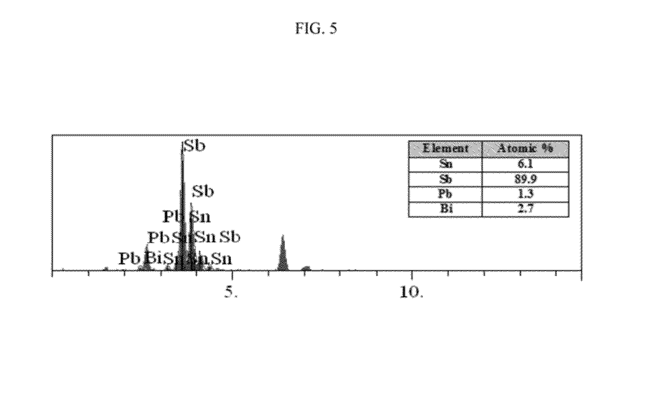

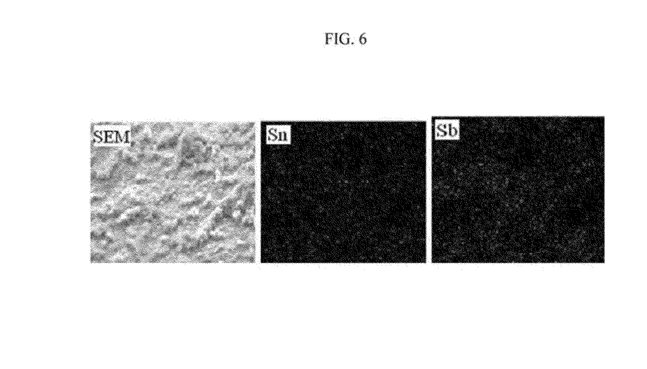

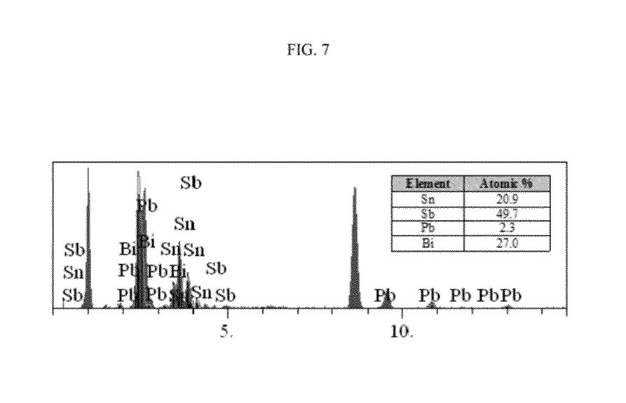

The foils were gently removed from the mixture after the reaction and dip-washed with ethanol and deioned water for several times. The products were air dried at 25° C. or vacuum dried at 50° C. and were further characterized with powder X-ray diffraction (XRD), scanning electron microscopy (SEM), and energy dispersive X-ray spectroscopy (EDX). FIG. 3 shows XRD patterns of (a) Fe/SnSb and (b) Zn/SnSb product respectively. FIG. 4 shows an SEM image and electron mapping on a Fe/SnSb product. FIG. 5 shows the composition of the Fe/SnSb product shown in FIG. 4. FIG. 6 shows an SEM image and electron mapping on a Zn/SnSb product. These data show the presence of both Sn and Sb. FIG. 7 shows the composition of the Zn/SnSb product shown in FIG. 6.

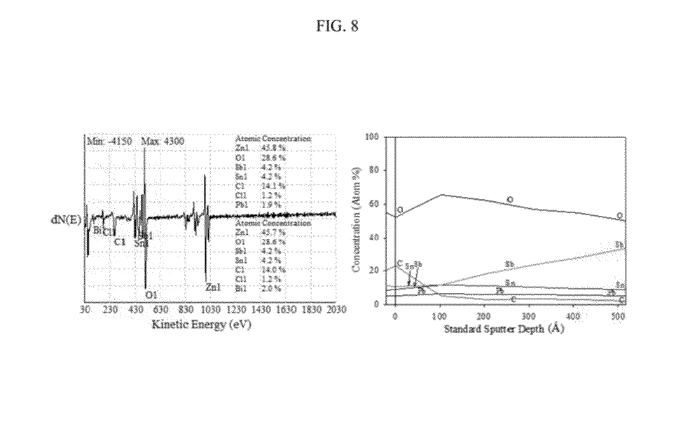

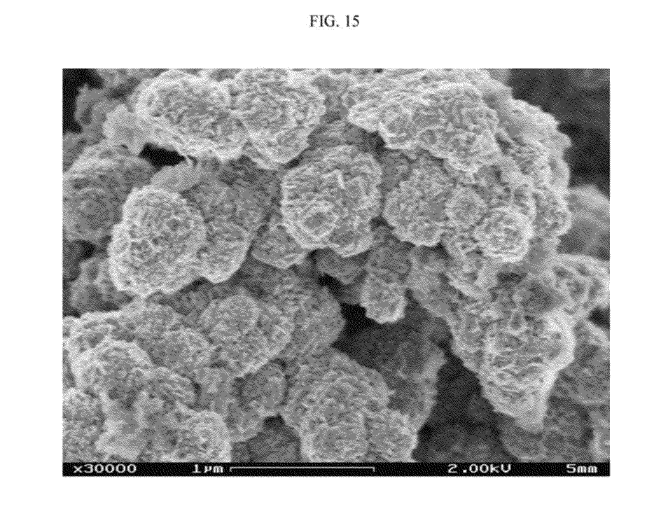

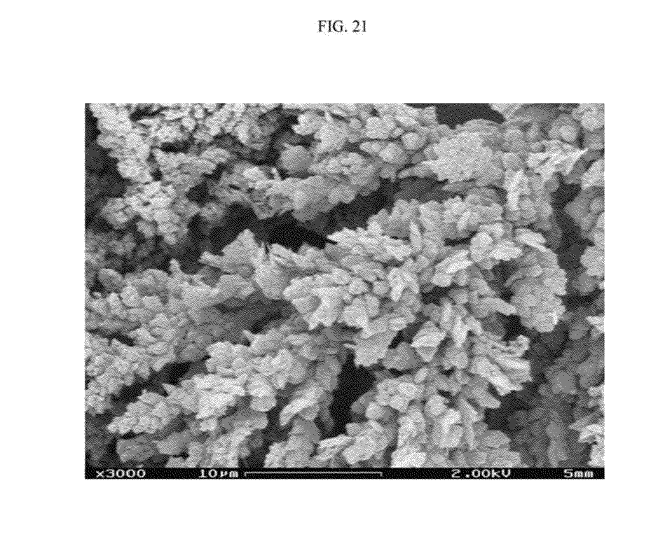

Different substrates can lead to different compositions, which most likely due to different reducing potential of different metals. FIGS. 15 and 21 show FE-SEM images of Fe/SnSb and Zn/SnSb products respectively. Unique nanocubics can be observed from Fe substrate produced alloys. Zn substrate leads to the formation of dendrite shaped alloys and relatively larger size particles, which is due to the better reducing potential of Zn metal. FIG. 8 shows the Auger analysis of a Zn/SnSb product. Both Sn and Sb can be observed. Oxygen is presented due to the easily oxidation nature of nano-sized Sn in air, which is also presented in a commercial APSI catalyst.

### Example 2

Other substrate cored-metal layer shelled metal alloys were prepared in accordance with the methodology shown in FIG. 9. Metal foils were suspended in a container, which was filled with suitable single or mixed metal salt precursors and mixed organic solvents for different times at variable temperatures as illustrated in FIG. 2. Relatively active metal foils were Mg, Al, Zn, Fe, Ni, and the like. A refrigerator or ice bath was used to control the reaction temperatures at 0° C.-2° C. when necessary; otherwise the reaction was done at ambient temperature. The cationic part of metallic precursors contained one or several metals like Sn, Pb, Sb, Bi, Co, Ni, In, Cu, Hg, Ag, Pt, Pd, and Au, while the anionic part contained sulfate, nitrate, chloride, acetate, or acetylacetonate. The organic solvents used were one or several of the type ethanol and ethylene glycol. The reaction time was set between 30 minutes and 12 hours.

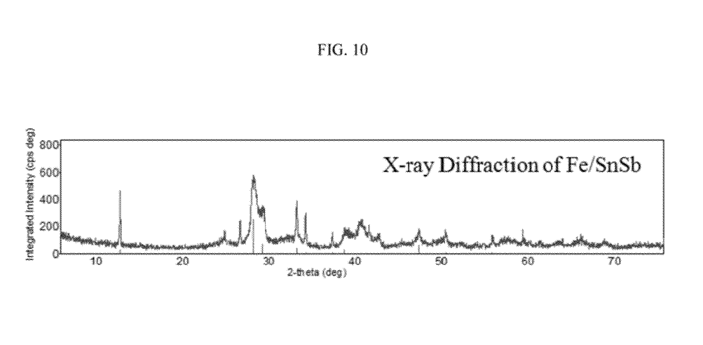

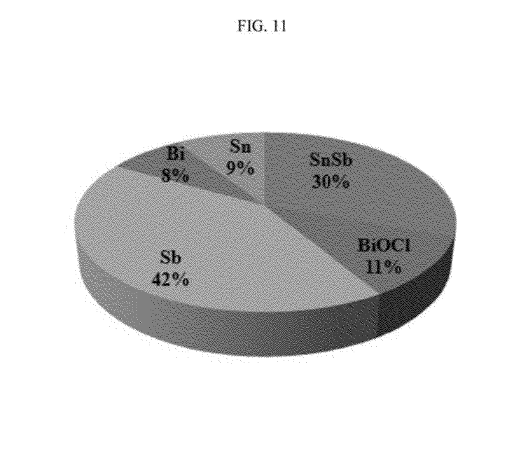

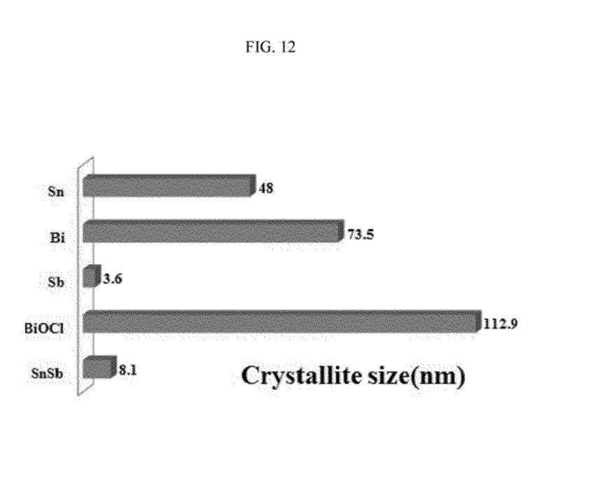

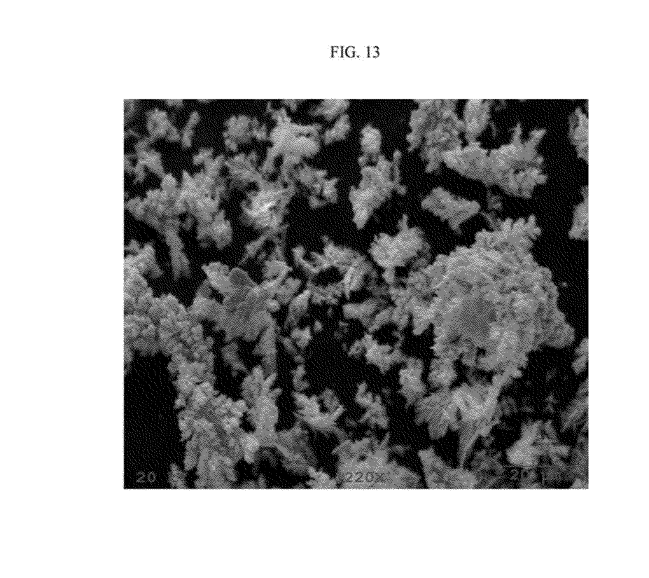

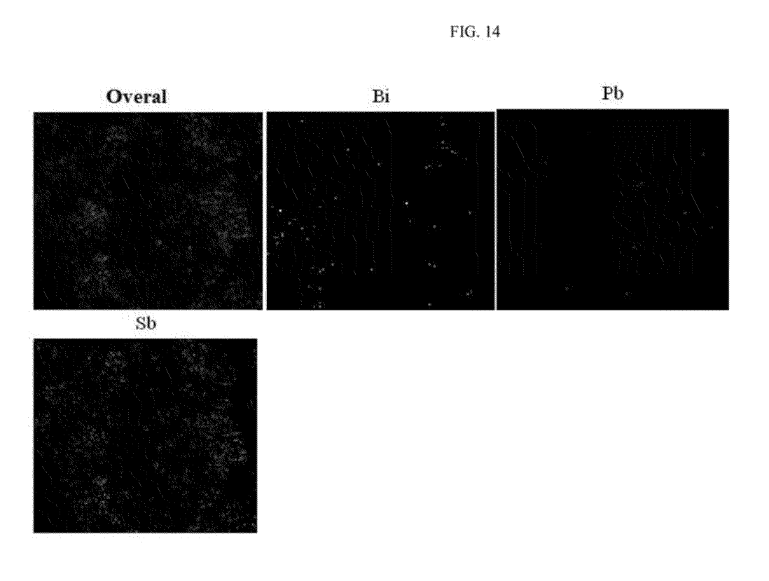

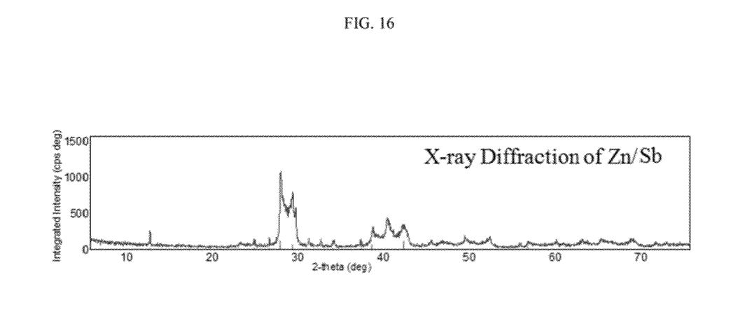

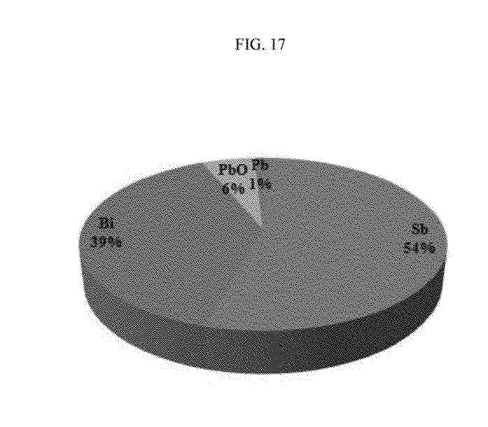

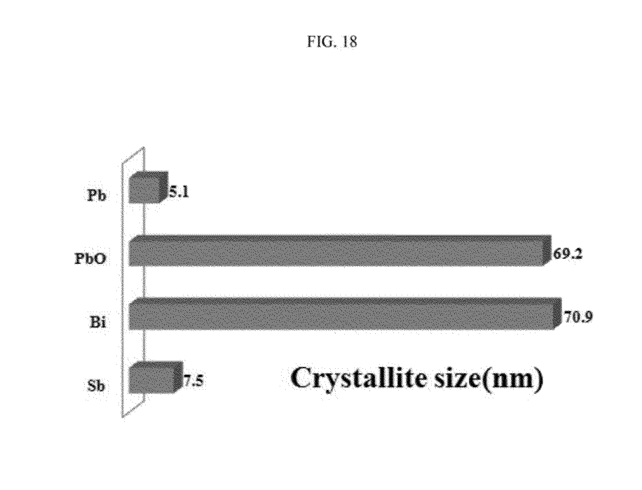

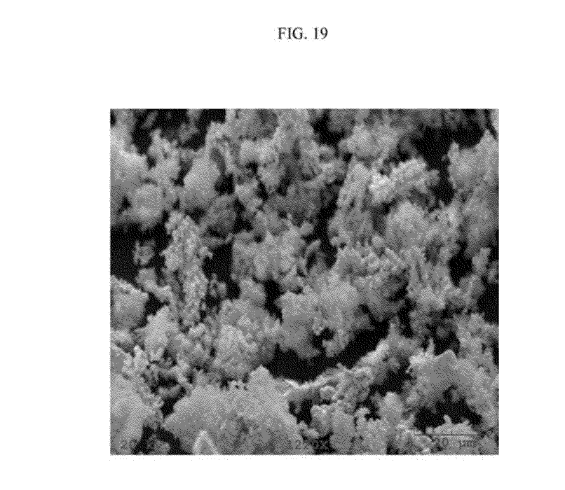

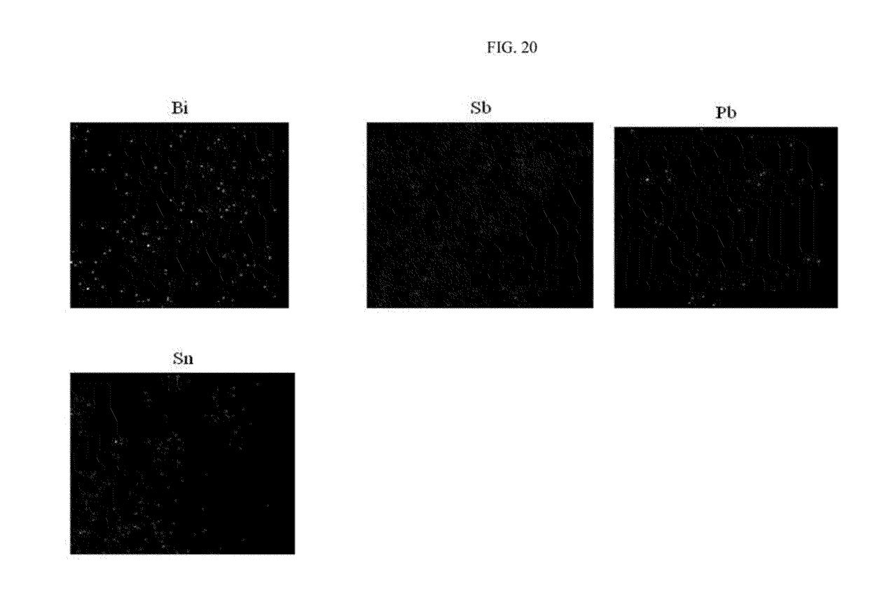

The procedure used was similar to that used in Example 1. The foils were gently removed from the mixture after the reaction and dip-washed with ethanol and deioned water for several times. The products were air dried at 25° C. or vacuum dried at 50° C. and were further characterized with powder X-ray diffraction (XRD), scanning electron microscopy (SEM), and energy dispersive X-ray spectroscopy (EDX). FIG. 10 shows x-ray diffraction (XRD) patterns of a Fe/SnSb product. FIG. 11 graphically depicts a compositional analysis of the Fe/SnSb product of FIG. 10. FIG. 12 graphically depicts crystallite size (nanometers) of the Fe/SnSb product of FIG. 10. FIG. 13 shows a scanning electron microscopy (SEM) image of a Fe/SnSb product. FIG. 14 shows energy dispersive x-ray (EDX) spectroscopy mapping of a Fe/SnSb product. FIG. 15 depicts a high resolution scanning electron microscopy (SEM) image of a Fe/SnSb product. FIG. 16 shows x-ray diffraction (XRD) patterns of a Zn/Sb product. FIG. 17 graphically depicts a compositional analysis of the Zn/Sb product of FIG. 16. FIG. 18 graphically depicts crystallite size (nanometers) of the Zn/Sb product of FIG. 16. FIG. 19 shows a scanning electron microscopy (SEM) image of a Zn/Sb product. FIG. 20 shows energy dispersive x-ray (EDX) spectroscopy mapping of a Zn/Sb product.

### Example 3

### Procedure for the Treatment of Compounds with the Substrate Cored-Metal Layer Shelled Metal Alloy Catalyst of this Disclosure and a Comparative Catalyst

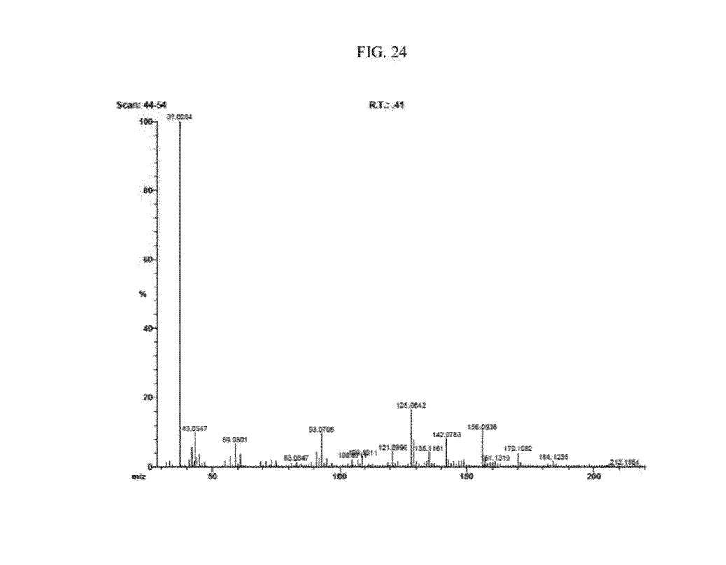

A mixture (FIG. 24) of naphthalene (100.0 milligrams) dissolved in toluene (4.0 milliliters) and gasoline (0.5 milliliters) along with a substrate cored-metal layer shelled metal alloy catalyst of this disclosure were stirred under constant shaking for one hour. The treated sample was analyzed with AccuTOF-DART (Direct Analysis in Real Time). The mode of analysis chosen was positive ionization, which is ideal for alkanes, alkenes, and aromatics. The DART method utilizes the high-resolution and accurate mass capability of the AccuTOF time-of-flight mass spectrometer to analyze various components of the analytes having different mass. Other mixtures were also prepared and analyzed as shown in the Tables 1 and 2 below. Table 1 shows illustrative compounds after treating with the substrate cored-metal layer shelled metal alloy catalyst of this disclosure. Table 2 shows illustrative compounds after treating with the substrate cored-metal layer shelled metal alloy catalyst of this disclosure and a comparative catalyst.

As used herein, the comparative catalyst was a SnSb type catalyst and consisted of a powder of nanoparticles. The comparative catalyst was not a substrate cored-metal layer shelled metal alloy.

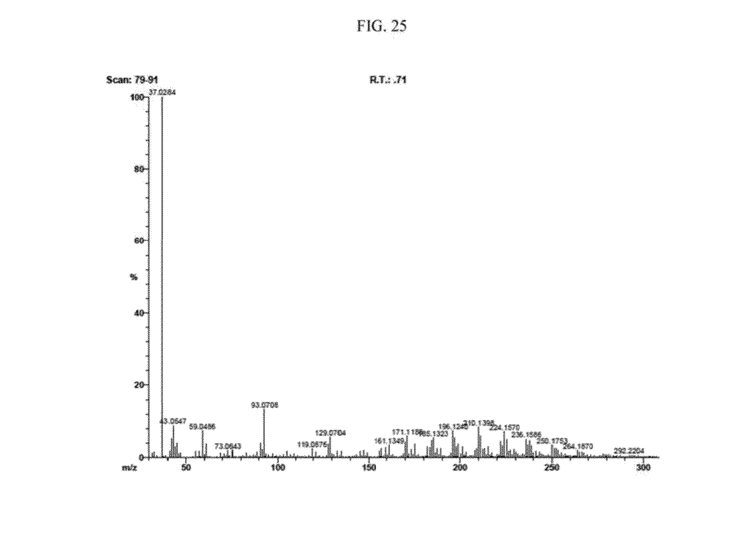

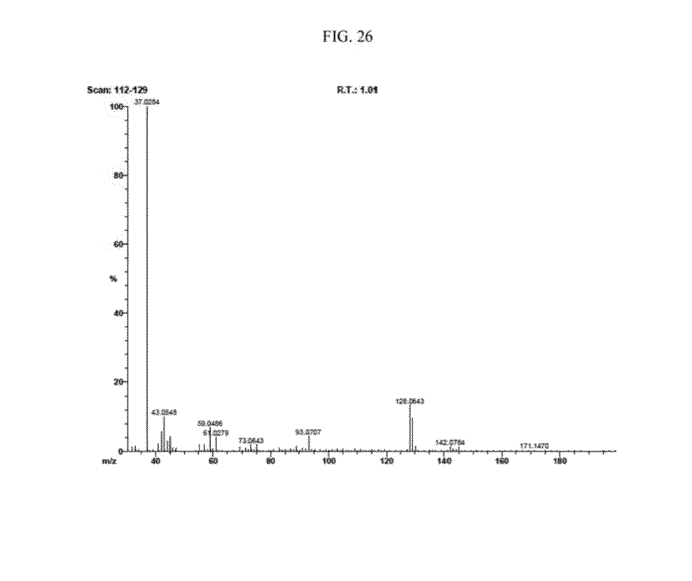

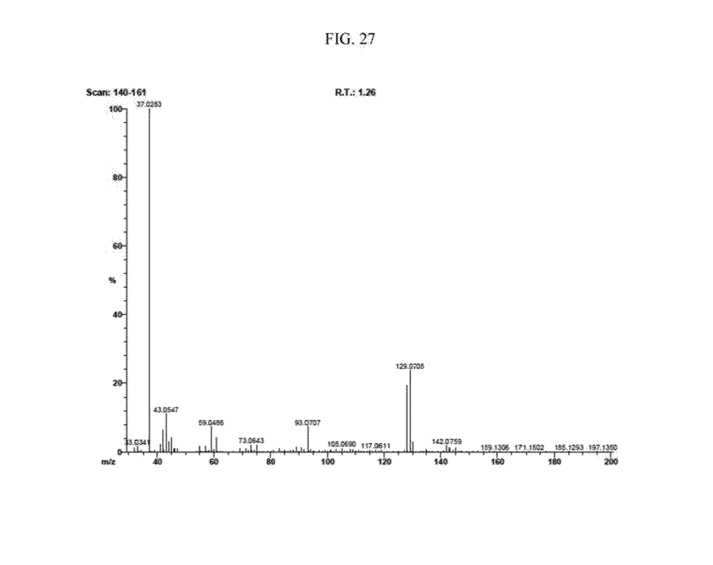

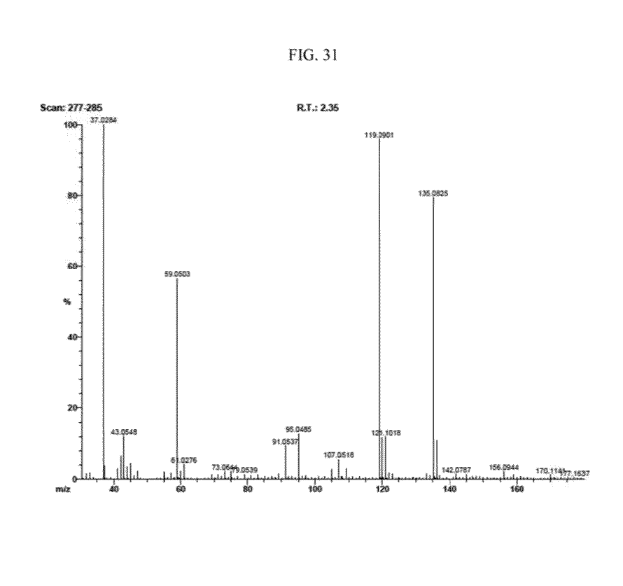

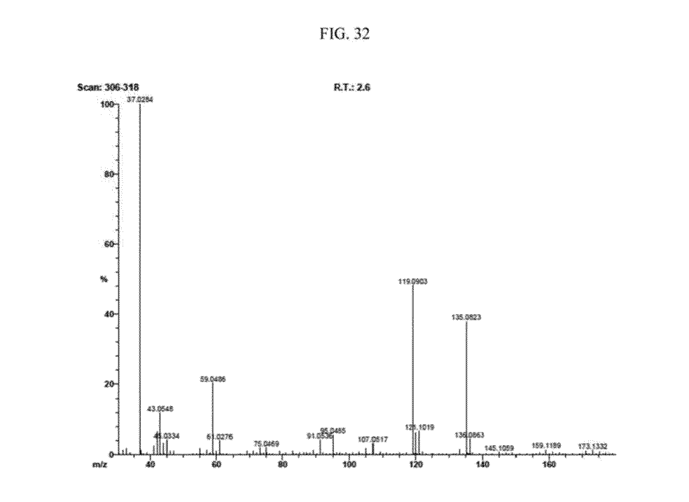

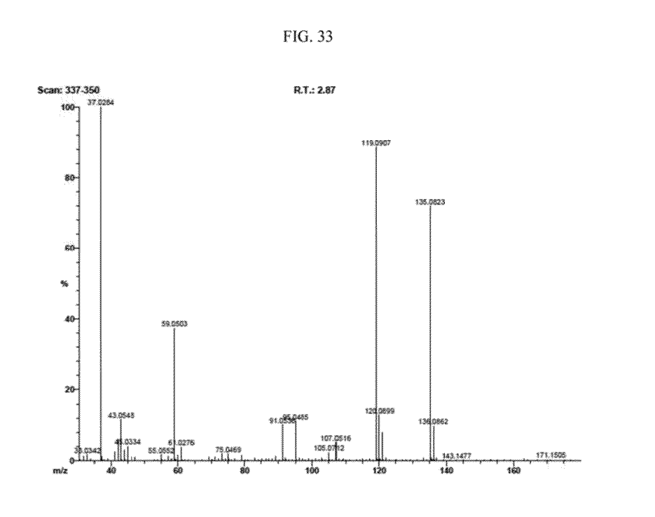

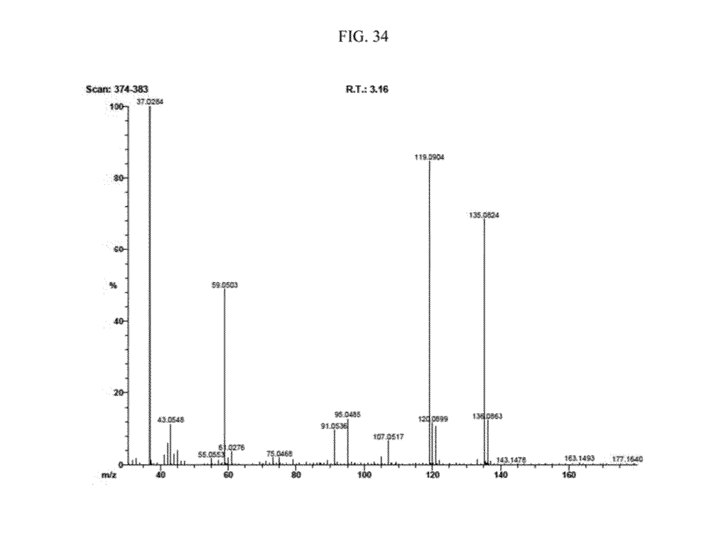

TABLE 1

| | Naphthalene | Cumene |
|---|---|---|
| Gasoline | FIG. 24 | FIG. 31 |
| Diesel fuel | FIG. 25 | FIG. 32 |
| Pentane | FIG. 26 | FIG. 33 |
| Hexanes | FIG. 27 | FIG. 34 |

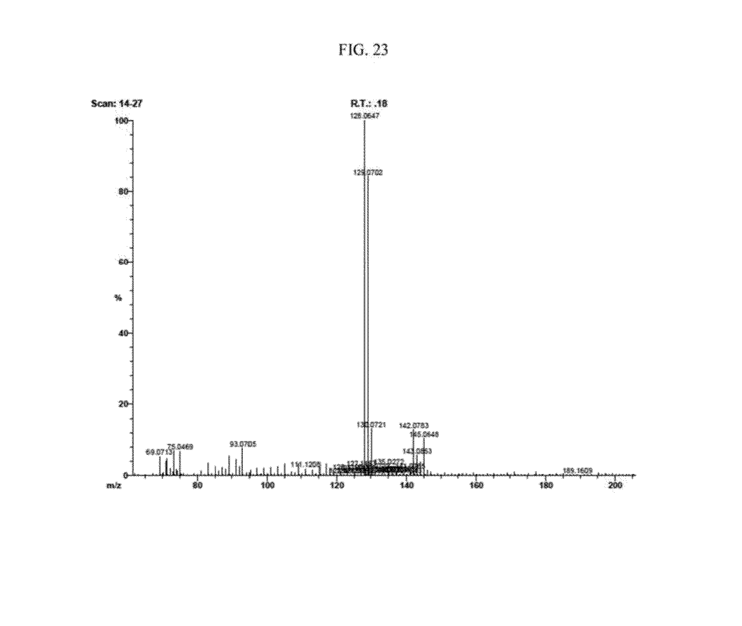

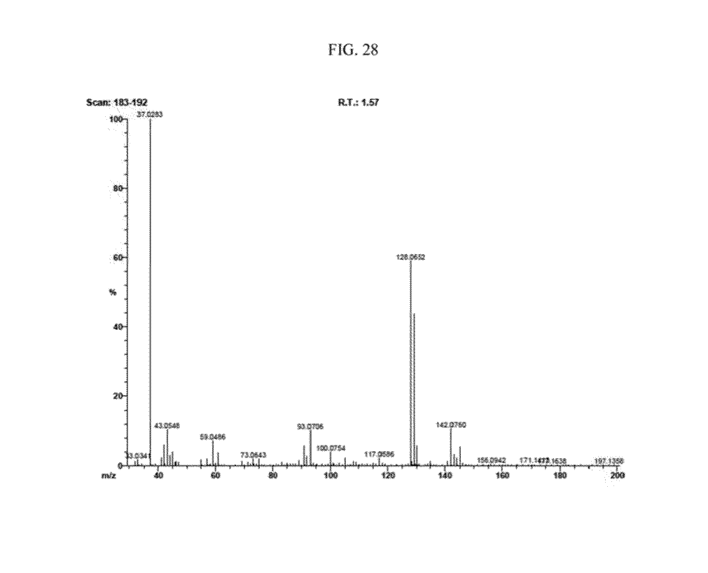

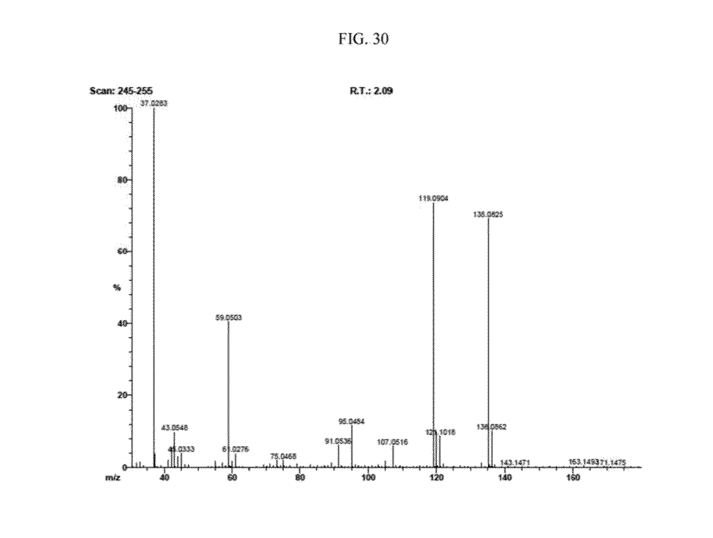

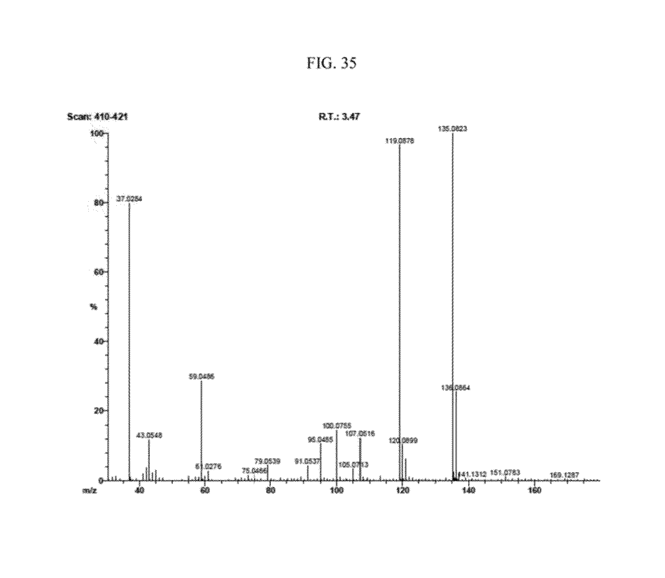

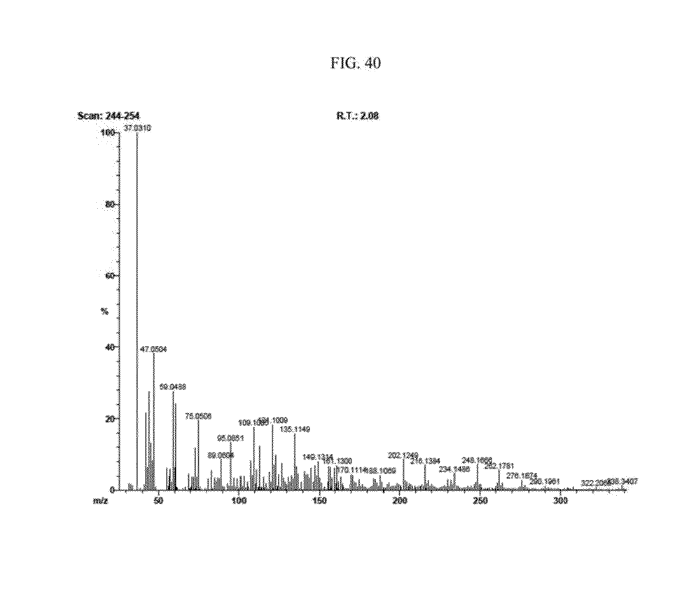

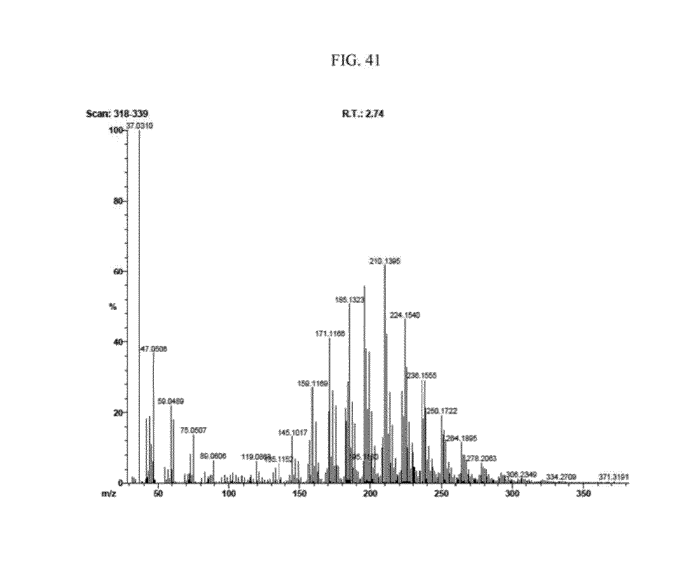

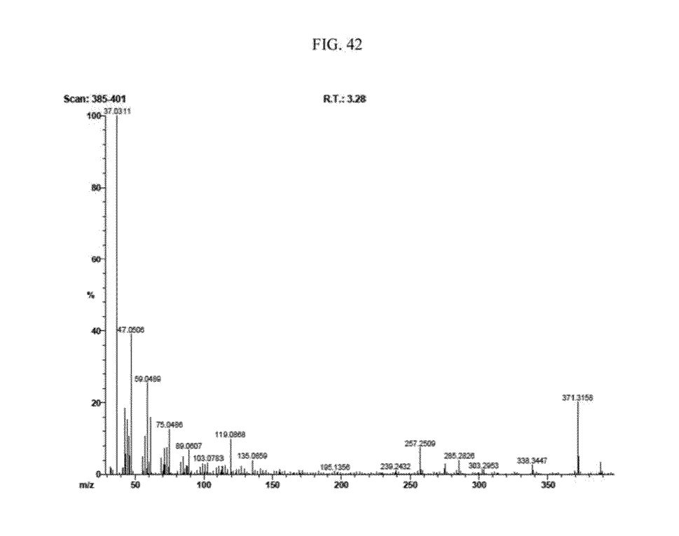

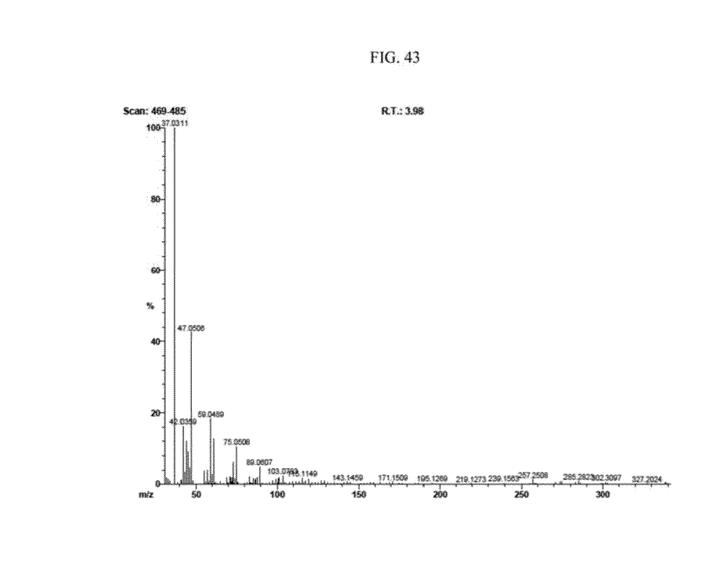

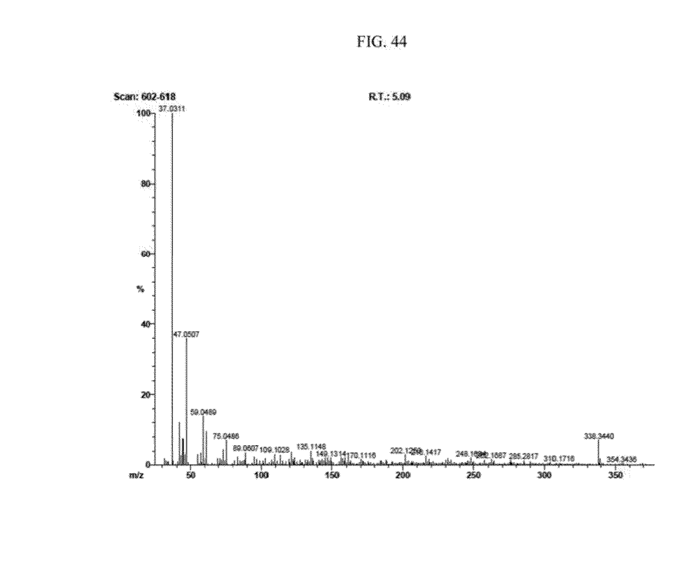

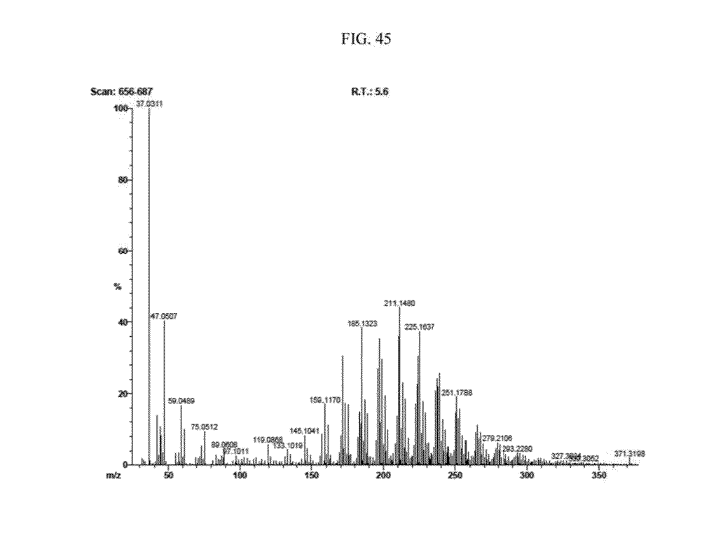

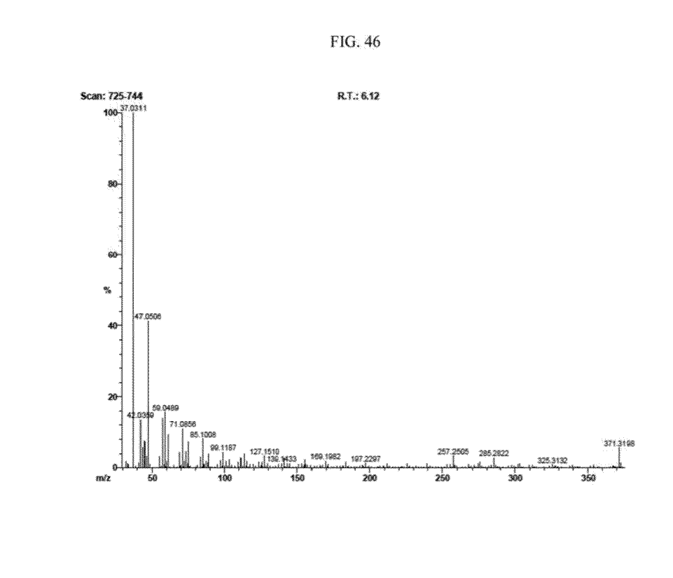

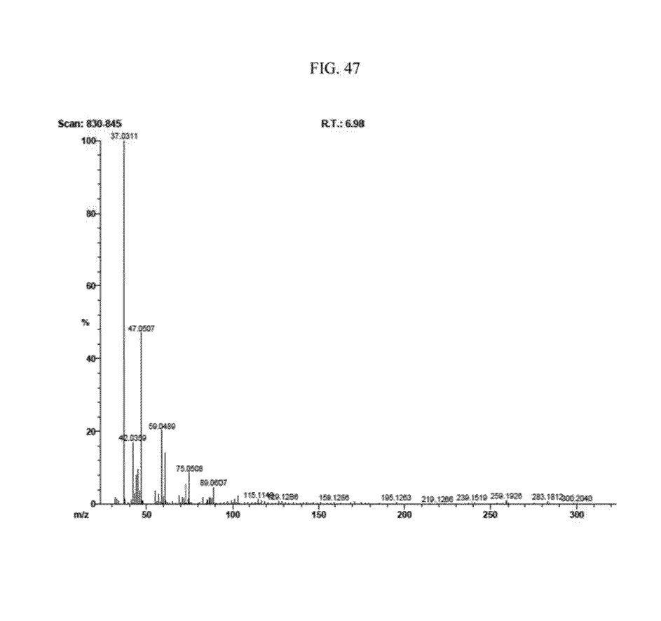

TABLE 2

| | Alloy Cat | Comparative Cat |
|---|---|---|
| Naphthalene | FIG. 23 | FIG. 28 |
| Cumene | FIG. 30 | FIG. 35 |
| Gasoline | FIG. 40 | FIG. 44 |
| Diesel fuel | FIG. 41 | FIG. 45 |
| Pentane | FIG. 42 | FIG. 46 |
| Hexanes | FIG. 43 | FIG. 47 |

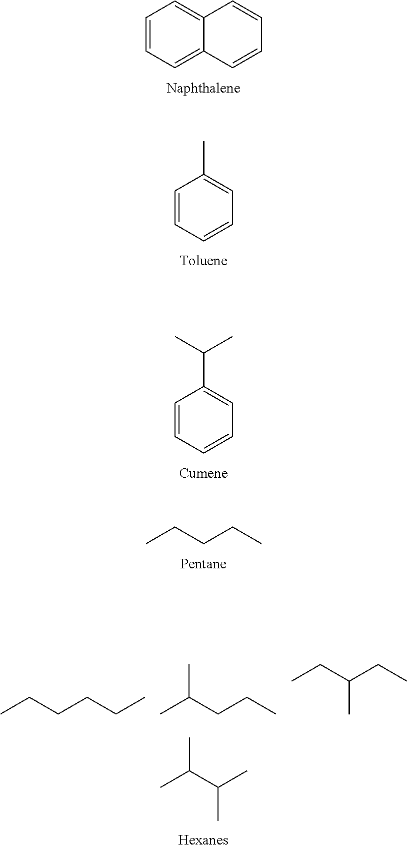

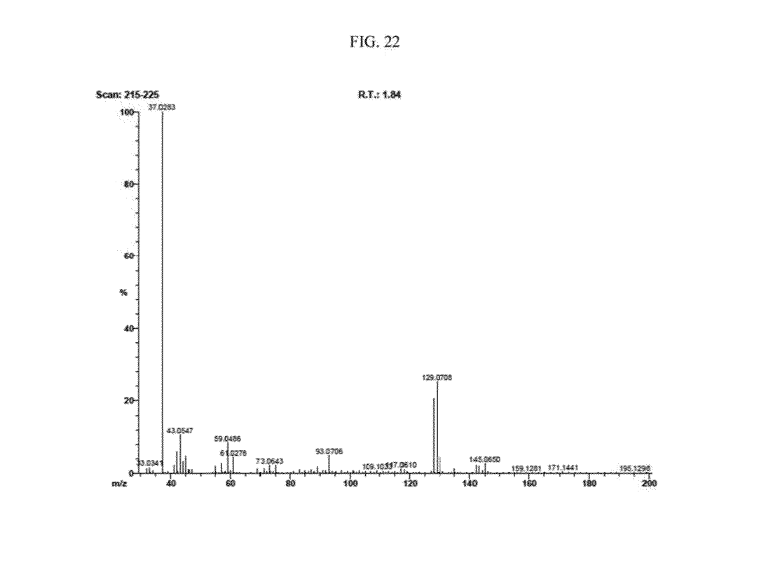

FIG. 22 depicts the AccuTOF-DART (Direct Analysis in Real Time) analysis results (naphthalene (M.W. 128)+toluene (M.W. 92)) untreated. FIG. 23 depicts the AccuTOF-DART (Direct Analysis in Real Time) analysis results (naphthalene (M.W. 128)+toluene (M.W. 92)+alloy cat) from the treatment of compounds with a substrate cored-metal layer shelled metal alloy catalyst. FIG. 24 depicts the AccuTOF-DART (Direct Analysis in Real Time) analysis results (naphthalene (M.W. 128)+toluene (M.W. 92)+gasoline+alloy cat) from the treatment of compounds with a substrate cored-metal layer shelled metal alloy catalyst. FIG. 25 depicts the AccuTOF-DART (Direct Analysis in Real Time) analysis results (naphthalene (M.W. 128)+toluene (M.W. 92)+diesel fuel+alloy cat) from the treatment of compounds with a substrate cored-metal layer shelled metal alloy catalyst. FIG. 26 depicts the AccuTOF-DART (Direct Analysis in Real Time) analysis results (naphthalene (M.W. 128)+toluene (M.W. 92)+pentane (M.W. 72)+alloy cat) from the treatment of compounds with a substrate cored-metal layer shelled metal alloy catalyst. FIG. 27 depicts the AccuTOF-DART (Direct Analysis in Real Time) analysis results (naphthalene (M.W. 128)+toluene (M.W. 92)+hexanes (M.W. 86)+alloy cat) from the treatment of compounds with a substrate cored-metal layer shelled metal alloy catalyst.

FIG. 28 depicts the AccuTOF-DART (Direct Analysis in Real Time) analysis results (naphthalene (M.W. 128)+toluene (M.W. 92)+comparative cat) from the treatment of compounds with a comparative catalyst.

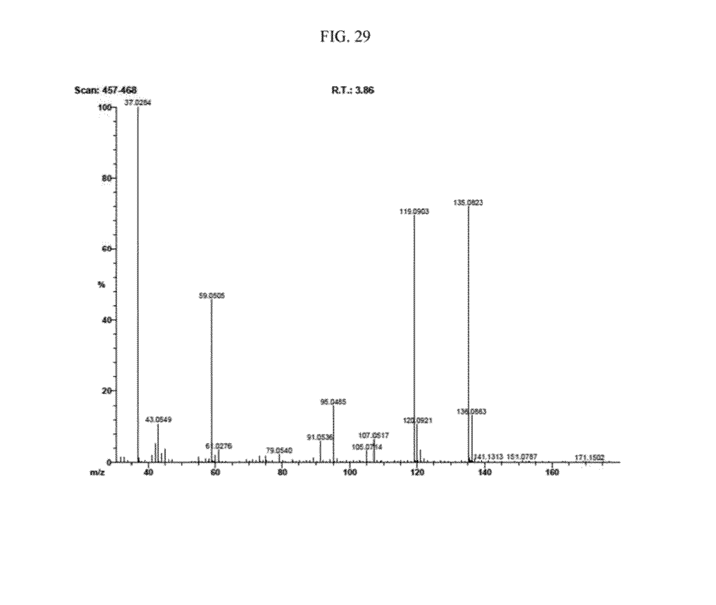

FIG. 29 depicts the AccuTOF-DART (Direct Analysis in Real Time) analysis results (cumene (M.W. 120)) untreated. FIG. 30 depicts the AccuTOF-DART (Direct Analysis in Real Time) analysis results (cumene (M.W. 120)+alloy cat) from the treatment of compounds with a substrate cored-metal layer shelled metal alloy catalyst. FIG. 31 depicts the AccuTOF-DART (Direct Analysis in Real Time) analysis results (cumene (M.W. 120)+gasoline+alloy cat) from the treatment of compounds with a substrate cored-metal layer shelled metal alloy catalyst. FIG. 32 depicts the AccuTOF-DART (Direct Analysis in Real Time) analysis results (cumene (M.W. 120)+diesel fuel+alloy cat) from the treatment of compounds with a substrate cored-metal layer shelled metal alloy catalyst. FIG. 33 depicts the AccuTOF-DART (Direct Analysis in Real Time) analysis results (cumene (M.W. 120)+pentane (M.W. 72)+alloy cat) from the treatment of compounds with a substrate cored-metal layer shelled metal alloy catalyst. FIG. 34 depicts the AccuTOF-DART (Direct Analysis in Real Time) analysis results (cumene (M.W. 120)+hexanes (M.W. 86)+alloy cat) from the treatment of compounds with a substrate cored-metal layer shelled metal alloy catalyst.

FIG. 35 depicts the AccuTOF-DART (Direct Analysis in Real Time) analysis results (cumene (M.W. 120)+comparative cat) from the treatment of compounds with a comparative catalyst.

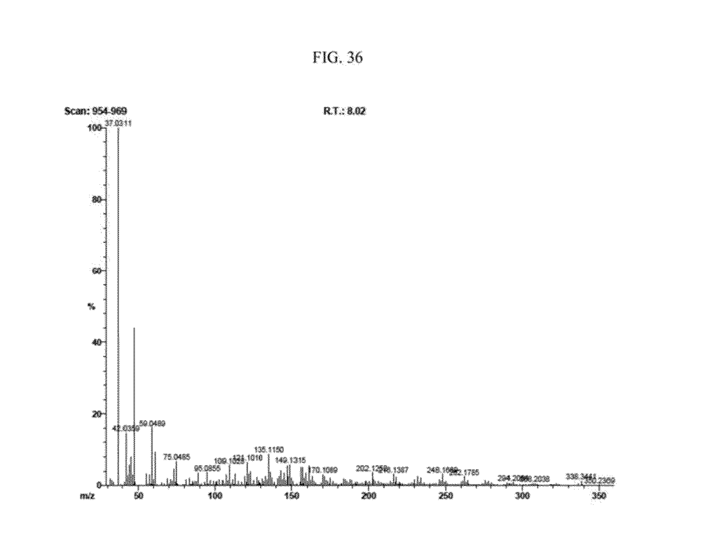

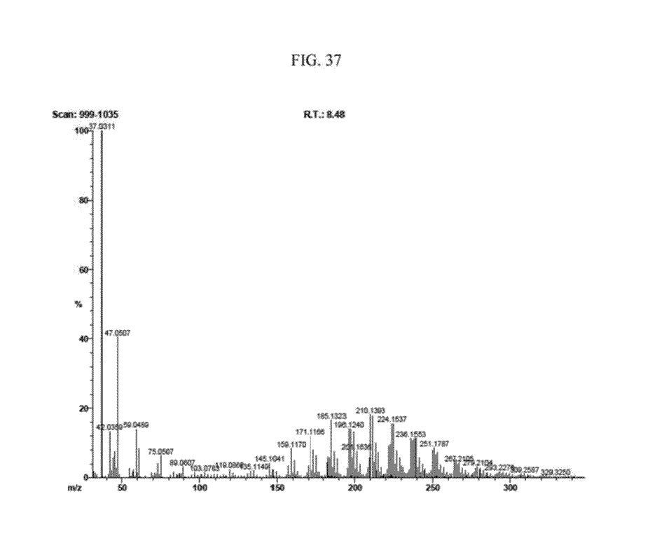

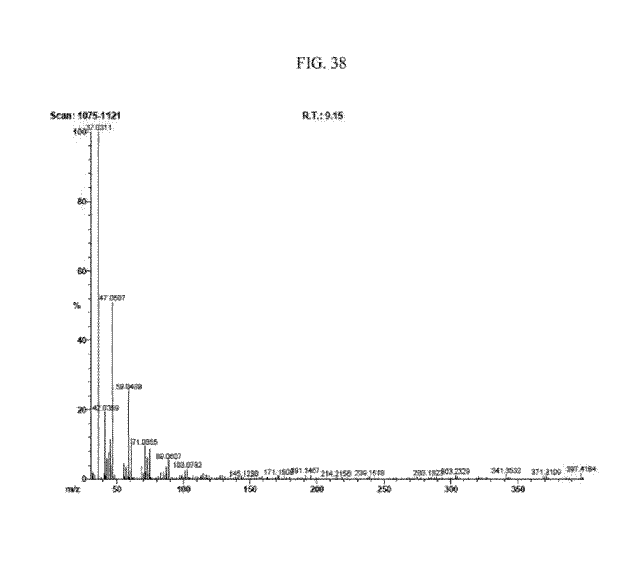

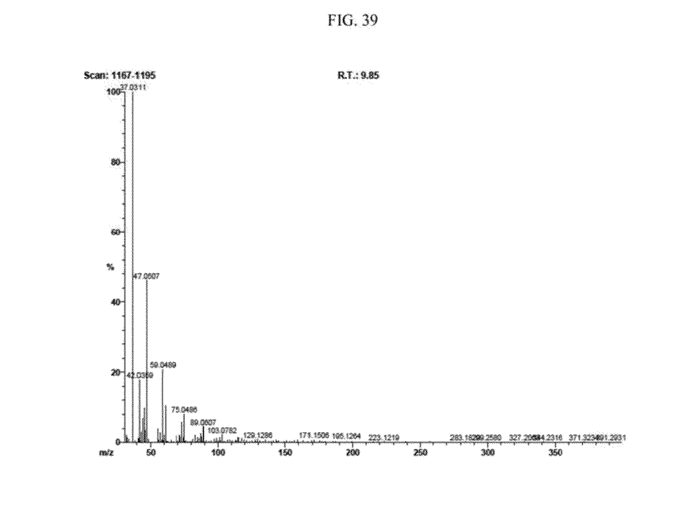

FIG. 36 depicts the AccuTOF-DART (Direct Analysis in Real Time) analysis results (gasoline) untreated. FIG. 37 depicts the AccuTOF-DART (Direct Analysis in Real Time) analysis results (diesel fuel) untreated. FIG. 38 depicts the AccuTOF-DART (Direct Analysis in Real Time) analysis results (pentane (M.W. 72)) untreated. FIG. 39 depicts the AccuTOF-DART (Direct Analysis in Real Time) analysis results (hexanes (M.W. 86)) untreated.

FIG. 40 depicts the AccuTOF-DART (Direct Analysis in Real Time) analysis results (gasoline+alloy cat) from the treatment of compounds with a substrate cored-metal layer shelled metal alloy catalyst. FIG. 41 depicts the AccuTOF-DART (Direct Analysis in Real Time) analysis results (diesel fuel+alloy cat) from the treatment of compounds with a substrate cored-metal layer shelled metal alloy catalyst. FIG. 42 depicts the AccuTOF-DART (Direct Analysis in Real Time) analysis results (pentane (M.W. 72)+alloy cat) from the treatment of compounds with a substrate cored-metal layer shelled metal alloy catalyst. FIG. 43 depicts the AccuTOF-DART (Direct Analysis in Real Time) analysis results (hexanes (M.W. 86)+alloy cat) from the treatment of compounds with a substrate cored-metal layer shelled metal alloy catalyst.

FIG. 44 depicts the AccuTOF-DART (Direct Analysis in Real Time) analysis results (gasoline+comparative cat) from the treatment of compounds with a comparative catalyst. FIG. 45 depicts the AccuTOF-DART (Direct Analysis in Real Time) analysis results (diesel fuel+comparative cat) from the treatment of compounds with a comparative catalyst. FIG. 46 depicts the AccuTOF-DART (Direct Analysis in Real Time) analysis results (pentane (M.W. 72)+comparative cat) from the treatment of compounds with a comparative catalyst. FIG. 47 depicts the AccuTOF-DART (Direct Analysis in Real Time) analysis results (hexanes (M.W. 86)+comparative cat) from the treatment of compounds with a comparative catalyst.

Several results can be determined from the testing. Analysis shows the peaks for water molecules at m/z 37 and 73 are for [(H₂O)₂+H]⁺ and [(H₂O)₄+H]⁺. Naphthalene, cumene and toluene molecules at m/z 129, 119 and 93 are for [C₁₀H₈+H]⁺, [C₉H₁₂—H]⁺ and [C₇H₈+H]⁺. Peak at m/z 43, 59, 75, 91, 100, 105 and 135 may be from [C₃—H₇]⁺, [C₄H₁₀+H]⁺, [(C₇H₈+H)H₂O]⁺, [C₇H₈—H]⁺, [C₇H₁₆]⁺, [C₆H₅—CH—CH₃]⁺, [(C₁₀H₈+O)—H]⁺. Peaks at m/z 95, 107, 121, 142, 156, 170 may need to be assigned. The increase in m/z 14 increments (for peaks 142, 156 and 170) may be from the change in —CH₂— chain length. Naphthalene didn't show much change after the reaction.

For cumene after the reaction, FIG. 35 shows an extra peak at m/z 100.0755. This may be possibly from

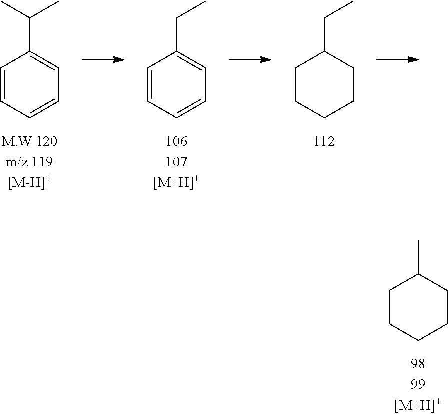

For gasoline and diesel fuel, after the reaction in both (alloy cat & comparative cat) the cases intensities are almost the same. A longer reaction time may be needed for them. For pentane, one case (FIG. 42) there are different components compared to other two (FIGS. 38 and 46). For hexanes, not much change after the reaction in both the cases. A combination of the molecules didn't show much difference from the individual molecules.

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

The present disclosure has been described above with reference to numerous embodiments and specific examples. Many variations will suggest themselves to those skilled in this art in light of the above detailed description. All such obvious variations are within the full intended scope of the appended claims. Also, the subject matter of the appended dependent claims is within the full intended scope of all appended independent claims.

What is claimed is:

1. A process comprising:
contacting a metal substrate with a bath, wherein the bath comprises one or more metallic precursors and one or more organic solvents; and
conducting a replacement reaction between the metal substrate and the one or more metallic precursors;
wherein the replacement reaction is conducted under controlled reaction conditions sufficient to produce one or more substrate cored-metal layer shelled metal alloys.

2. The process of claim 1, further comprising controlling the replacement reaction rate sufficient to produce the one or more substrate cored-metal layer shelled metal alloys.

3. The process of claim 1, further comprising controlling the replacement reaction pressure, temperature and reaction time sufficient to produce the one or more substrate cored-metal layer shelled metal alloys.

4. The process of claim 1, wherein the one or more substrate cored-metal layer shelled metal alloys comprise nanometer or micrometer sized grains.

5. The process of claim 1, wherein the replacement reaction is conducted under atmospheric pressure, at a reaction temperature from about −5° C. to about 5° C., and at a reaction time from about 30 minutes to about 6 hours.

6. The process of claim 1, wherein the metal substrate comprises at least one of magnesium (Mg), aluminum (Al), iron (Fe), and zinc (Zn).

7. The process of claim 1, wherein the one or more metallic precursors comprise at least one of tin (Sn), lead (Pb), antimony (Sb), bismuth (Bi), cobalt (Co), nickel (Ni), indium (In), copper (Cu), mercury (Hg), silver (Ag), platinum (Pt), palladium (Pd), and gold (Au).

8. The process of claim 1, wherein the one or more metallic precursors comprise a cationic portion and an anionic portion, wherein the cationic portion comprises at least one of tin (Sn), lead (Pb), antimony (Sb), bismuth (Bi), cobalt (Co), nickel (Ni), indium (In), copper (Cu), mercury (Hg), silver (Ag), platinum (Pt), palladium (Pd), and gold (Au), and wherein the anionic portion comprises at least one of sulfate, nitrate, chloride, acetate and acetylacetonate.

9. The process of claim 1, wherein, for the one or more substrate cored-metal layer shelled metal alloys, the substrate core comprises at least one of magnesium (Mg), aluminum (Al), iron (Fe), and zinc (Zn), and the metal layer shell comprises at least one of tin (Sn), lead (Pb), antimony (Sb), bismuth (Bi), cobalt (Co), nickel (Ni), indium (In), copper (Cu), mercury (Hg), silver (Ag), platinum (Pt), palladium (Pd), and gold (Au).

10. The process of claim 1, wherein the one or more substrate cored-metal layer shelled metal alloys have an irregular shape or a regular shape.

11. The process of claim 10, wherein the irregular shape comprises flakes and the regular shape selected from the group consisting of sphere, sheet, film, mesh, and honeycomb.

12. The process of claim 1, wherein the replacement reaction is a galvanic replacement reaction.

13. The process of claim 1, wherein the one or more organic solvents are selected from the group consisting of ethanol, ethylene glycol, glycerol, diethylene glycol, and triethylene glycol.

14. The process of claim 1, further comprising adding one or more carbon based or silicon based materials to the bath to form an ink suspension.

15. The process of claim 14, wherein the one or more carbon based or silicon based materials are selected from the group consisting of carbon black, graphite, carbon nanotube, fullerene, and silicon nanomaterial.

16. The process of claim 14, further comprising forming a metallic alloy/carbon or metallic alloy/silicone nanocomposite from the ink suspension.

17. A substrate cored-metal layer shelled metal alloy prepared by the process of claim 1.

18. The substrate cored-metal layer shelled metal alloy of claim 17, which comprises a heterogeneous catalyst for a fuel reforming process.

19. The substrate cored-metal layer shelled metal alloy of claim 17, which comprises an electrode material for a Li battery for energy storage.

20. A metallic alloy/carbon or metallic alloy/silicone nanocomposite prepared by the process of claim 16.
